(19) United States
(12) Patent Application Publication
(10) Pub. No.: US 2026/0223814 A1
(43) Pub. Date: Aug. 6, 2026

(54) ANIMAL ENRICHMENT DEVICE

(71) Applicant: Bounce Enterprises LLC, Golden, CO (US)

(72) Inventor: Joseph P. Markham, Golden, CO (US)

(21) Appl. No.: 19/044,879

(22) Filed: Feb. 4, 2025

(51) Int. Cl. A01K 5/02

(52) U.S. Cl. CPC A01K 5/025

(57) ABSTRACT

A device may include a core having a center, a first end opposite a second end. The device may include a first wheel extending from a location proximal the first end of the core and having a first wheel radius. The device may include a second wheel extending from a location proximal the second end of the core and having a second wheel radius substantially similar to the first wheel radius, a delivery device coupled with the core; and wherein: the delivery device comprises a tip configured to deliver a substance, the tip having a delivery end, and a distance from the center to the delivery end is less than the first wheel radius and the second wheel radius.

### FIELD

The examples described relate generally to animal enrichment devices. In particular, but not by way of limitation, the present disclosure relates to systems, methods, and apparatuses for an animal enrichment device for improved animal engagement and delivery of a substance to the animal.

### BACKGROUND

Animal treat dispensers known in the art cover a range of forms from toys to food bowls. Typical devices dispense food from surfaces that are or may come in contact with a ground surface. In cases where these devices are operated outdoors or on a barn floor, animal feces are often present, which exposes the food to bacteria and viruses. Once the contaminated food is consumed by the animal, it can lead to disease, illness, and overall poor sanitation. For example, some traditional configurations include a hollow structure with holes. In this example, treats may be loaded into the hollow structure and dispense through the holes when an animal moves the hollow structure. These holes are typically exposed to ground surfaces, which can lead to the contamination of the treats.

Although there are a variety of treat dispensers that may provide animal engagement, it is important to have an engagement device with improved sanitation features, such as features to inhibit food or substances from contacting a ground surface.

Accordingly, these specific attributes and features of the examples described herein should be understood by one skilled in the art to sufficiently distinguish over the known prior art. The information included in this Background section of the specification is included for technical reference purposes only and is not to be regarded subject matter by which the scope of the present disclosure is to be bound.

### SUMMARY

In some aspects, the techniques described herein relate to an animal enrichment device including: a core having a center, a first end opposite a second end; a first wheel extending from a location proximal the first end of the core and having a first wheel radius; a second wheel extending from a location proximal the second end of the core and having a second wheel radius substantially similar to the first wheel radius; a delivery device coupled with the core; and wherein: the delivery device includes a tip configured to deliver a substance, the tip having a delivery end, and a distance from the center to the delivery end is less than the first wheel radius and the second wheel radius.

In some aspects, the techniques described herein relate to an animal enrichment device, further including: a delivery device mount defining a bore and extending from the core; and wherein: the delivery device further includes: a body, wherein the body extends through the bore of the delivery device mount, a base abutting the delivery device mount, and the base couples the body to the delivery device mount. In some aspects, the techniques described herein relate to an animal enrichment device, wherein, the tip: defines a cavity configured to hold the substance, and includes a discharge point; the discharge point includes a slit configured to transition from a closed position to an open position in response to a pressure applied to the discharge point; and the substance is configured to evacuate the cavity through the slit in the open position. In some aspects, the techniques described herein relate to an animal enrichment device, wherein: the core includes a first core; the delivery device includes a first delivery device; and further including: a second core having a center, a first end, and a second end, wherein the second wheel is extending from a location proximal the first end of the second core, a third wheel extending from a location proximal the second end of the second core and having a third wheel radius substantially similar to the first wheel radius and the second wheel radius, and a second delivery device configured to couple with the second core; the second delivery device having a tip having a delivery end; and a distance from the center of the second core to the delivery end of the tip of the second delivery device is less than the third wheel radius. In some aspects, the techniques described herein relate to an animal enrichment device, further including an engagement device one of coupled and integrated with the core between the first end and the second end, the engagement device having: a central portion including a central portion radius, and at least one rim extending from the central portion, the at least one rim having a rim radius; and wherein, the rim radius is greater than the central portion radius.

In some aspects, the techniques described herein relate to an animal enrichment device including: a delivery device mount defining a bore and configured to couple with a structure; and a delivery device coupled with the delivery device mount via the bore; wherein: the delivery device having a tip defining a cavity configured to hold a substance, the tip includes a discharge point, and the substance is configured to evacuate the cavity through the discharge point.

In some aspects, the techniques described herein relate to an animal enrichment device, wherein the delivery device further includes: a body configured to extend through the bore of the delivery device mount; and a base configured to abut a first surface of the delivery device mount and secure the body to the delivery device mount. In some aspects, the techniques described herein relate to an animal enrichment device, wherein the delivery device further includes a ring configured to extend through the bore of the delivery device mount and abut a second surface of the delivery device mount, the second surface of the delivery device mount including a surface opposite the first surface of the delivery device mount. In some aspects, the techniques described herein relate to an animal enrichment device, wherein: the delivery device includes a first delivery device; the bore of the delivery device mount is first bore; the delivery device mount defining a second bore; and further including: a second delivery device configured to couple with the delivery device mount via the second bore.

In some aspects, the techniques described herein relate to an animal enrichment device including: a body having an interior surface and a body length; a body cavity defined by the interior surface of the body; a core extending into the body cavity and having a core length; a first opening defined by a top portion of the body and exposing the body cavity and the core; and a second opening defined by the core; wherein the core length is less than the body length and the second opening is within the body cavity.

In some aspects, the techniques described herein relate to an animal enrichment device, further including: a third opening defined by the body and by the core; and a core cavity defined by the core and extending between the second opening and the third opening. In some aspects, the techniques described herein relate to an animal enrichment device, wherein: the body having a first body end opposite a second body end; the first opening defined by the body at the first body end; and the third opening defined by the body at the second body end. In some aspects, the techniques described herein relate to an animal enrichment device, wherein: the core having a first core end opposite a second core end; the second opening defined by the core at the first core end; and the third opening defined by the core at the second core end. In some aspects, the techniques described herein relate to an animal enrichment device, wherein: the first opening having a first opening length; the second opening having a second opening length, wherein the first opening length is greater than the second opening length; and the third opening having a third opening length, wherein the third opening length is greater than or equal to the second opening length and less than or equal to the first opening length. In some aspects, the techniques described herein relate to an animal enrichment device, wherein: the body having a spherical shape; the first opening truncating a first portion of the spherical shape; and the third opening truncating a second portion of the spherical shape. In some aspects, the techniques described herein relate to an animal enrichment device, wherein: the core cavity is configured to receive a first substance; and the body cavity is configured to receive a second substance. In some aspects, the techniques described herein relate to an animal enrichment device, wherein: the body having an exterior surface; the core having an interior surface and an exterior surface; the exterior surface of the body transitions into the interior surface of the core; and the interior surface of the body transitions into the exterior surface of the core. In some aspects, the techniques described herein relate to an animal enrichment device, wherein: the body having a bottom portion; the bottom portion of the body having an exterior surface that is substantially flat; and the bottom portion of the body having a thickness greater than a thickness of the body. In some aspects, the techniques described herein relate to an animal enrichment device, wherein: the body includes an elastomeric material. In some aspects, the techniques described herein relate to an animal enrichment device, wherein: the core length is greater than or equal to about 20% and less than or equal to about 80% of the body length.

In some aspects, the techniques described herein relate to an animal enrichment device including: a body having a proximal portion and a distal portion, wherein the proximal portion has a proximal portion radius and the distal portion has a distal portion radius less than the proximal portion radius; a base extending from the proximal portion of the body, wherein the base has a base radius greater than the proximal portion radius; and a tip extending from the distal portion of the body, wherein the tip: defines a cavity configured to hold a substance, and includes a discharge point, wherein the substance is configured to evacuate the cavity through the discharge point.

In addition to the exemplary aspects and embodiments described in this Summary, further aspects and embodiments will become apparent by reference to the drawings and by study of the following description. This Summary is not intended to identify key features or essential features of the claimed subject matter, nor is it intended to be used to limit the scope of the claimed subject matter.

### BRIEF DESCRIPTION OF THE DRAWINGS

FIG. 1A depicts an example of an animal enrichment device;

FIG. 1B depicts an example of an animal enrichment device;

FIG. 1C depicts an example of an animal enrichment device;

FIG. 2 is depicts a side or cross-sectional view of an example of an animal enrichment device;

FIG. 3 is depicts an example of an animal enrichment device;

FIG. 4 is depicts an example of an animal enrichment device;

FIG. 5 is depicts an example of an animal enrichment device;

FIG. 6 is depicts an example of a feature of an animal enrichment device;

FIG. 7A depicts an example of a section of an animal enrichment device;

FIG. 7B depicts an example of a section of an animal enrichment device;

FIG. 8 depicts an example of a feature of an animal enrichment device;

FIG. 9A depicts an example of a feature of an animal enrichment device;

FIG. 9B depicts a bottom perspective view of an example of a feature of an animal enrichment device;

FIG. 10A depicts an example of a feature of an animal enrichment device;

FIG. 10B depicts a bottom perspective view of an example of a feature of an animal enrichment device;

FIG. 11 depicts an example of an animal enrichment device coupled to a structure;

FIG. 12A depicts an example of an animal enrichment device coupled to a structure;

FIG. 12B depicts an example of an animal enrichment device coupled to a structure;

FIG. 12C depicts an example of an animal enrichment device coupled to a structure;

FIG. 13 depicts an isometric view of an example of an animal enrichment device;

FIG. 14 depicts a top isometric view of an example of an animal enrichment device;

FIG. 15 depicts a side, front, or rear view of an example of an animal enrichment device;

FIG. 16 depicts a top view of an example of an animal enrichment device;

FIG. 17 depicts a bottom view of an example of an animal enrichment device;

FIG. 18 depicts a bottom isometric view of an example of an animal enrichment device;

FIG. 19 depicts a bottom isometric view of an example of an animal enrichment device; and

FIG. 20 depicts a cross-sectional side, front, or rear view of an example of an animal enrichment device.

This Brief Description of the Drawings is not intended to identify essential features of the claimed subject matter, nor is it intended to be used to limit the scope of the claimed subject matter. A more extensive presentation of features, details, utilities, and advantages of the present disclosure is provided in the following written description of various embodiments of the claimed subject matter and illustrated in the accompanying drawings.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to animal enrichment devices. A delivery device coupled with an animal enrichment device may deliver a substance, such as food, treats, medicine, and the like, to animals, such as hogs, dogs, horses, and the like. For example, a delivery end of the delivery device may open in response to the animal engaging with a tip of the delivery device where the delivery end is located. The delivery device may be structured and/or coupled with the animal enrichment device (e.g., the delivery device may be structured as an integrated/unitary feature of the animal enrichment device, or the delivery device may be coupled, permanently or removably, to the animal enrichment device) such that the delivery end does not extend beyond elements of the animal enrichment device that may be or come into contact with a substantially level ground surface, e.g., in an operational orientation of the animal enrichment device. In this way, the delivery device may be inhibited from contacting the ground surface, e.g., in the operational orientation of the animal enrichment device, which can provide different advantages, including improved sanitation as compared to typical animal treat dispensers or engagement devices, and/or improved maneuvering of the animal enrichment device due to a reduction of frictional forces between elements of the animal enrichment device and the ground surface.

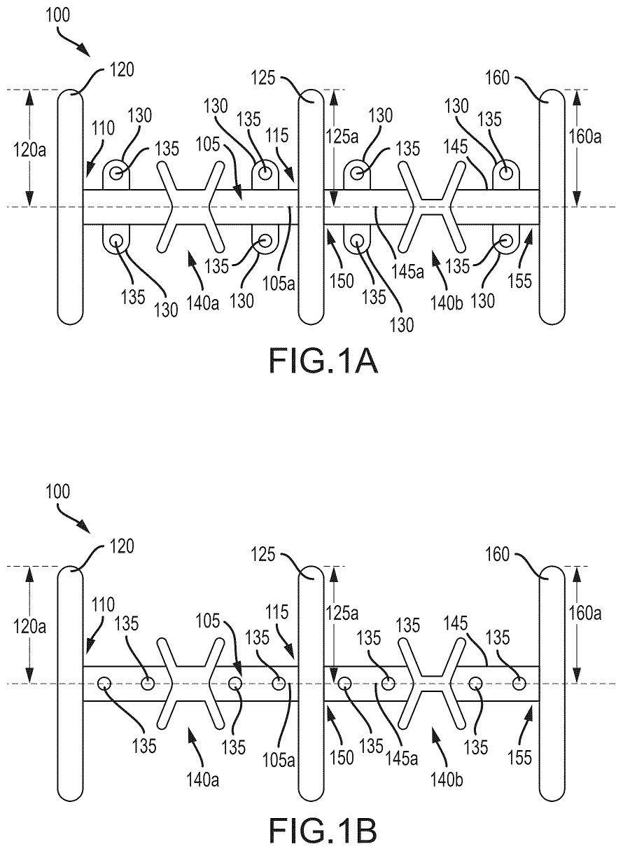

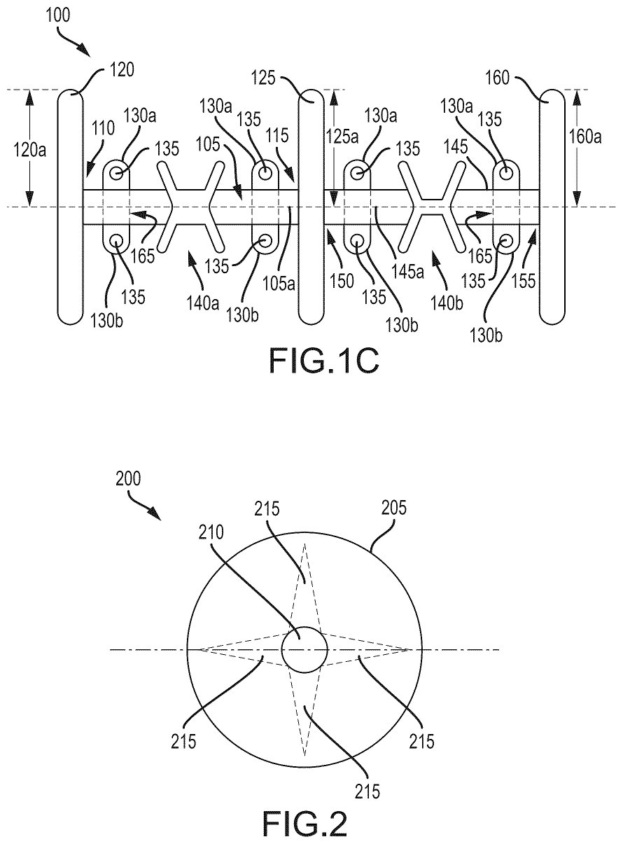

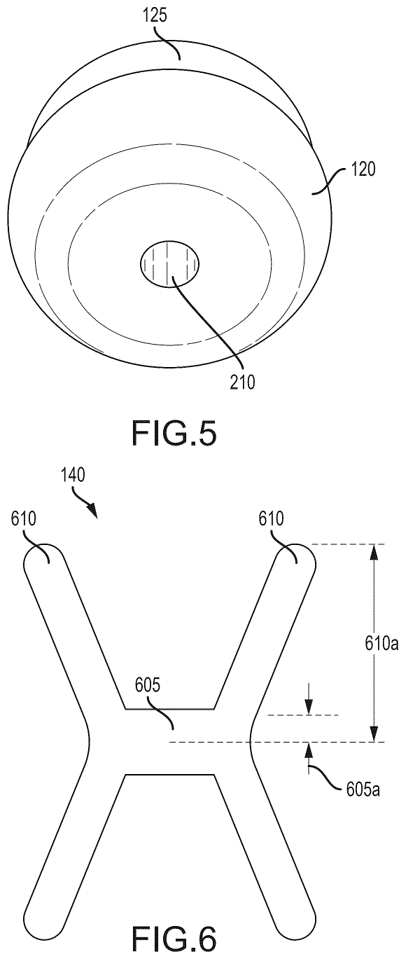

FIGS. 1A-10B depict examples of an animal enrichment device 100. The animal enrichment device 100 may include a hard material or a soft material. For example, the animal enrichment device 100 may include hard or substantially rigid materials, such as galvanized steel, melamine plastic, polymethyl methacrylate, polycarbonate, High-Density Polyethylene, Polyvinyl Chloride, Acrylonitrile Butadiene Styrene, Polytetrafluoroethylene, High Impact Polystyrene, metal, and the like. Additionally or alternatively, the animal enrichment device 100 may comprise or may include soft, elastomeric, or flexible materials, such as rubber, elastin, nylon, lycra, cartilage, silicone, and the like.

The animal enrichment device 100 may include a core 105. The core 105 may include a center 105a, such as a center point or center line. The core 105 may include a first end 110 or portion 110 and a second end 115 or portion 115. The first end 110 and the second end 115 may be opposite each other.

The animal enrichment device 100 may include a wheel, such as a first wheel 120 and a second wheel 125. The animal enrichment device 100 may include additional wheels. For example, the animal enrichment device 100 may include three wheels, eight wheels, seventeen wheels, and the like. The first wheel 120 may extend from a location proximal the first end 110 of the core 105, e.g., a location distal the second end 115 of the core 105. The second wheel 125 may extend from a location proximal the second end 115 of the core 105, e.g., a location distal the first end 110 of the core 105.

The wheels of the animal enrichment device 100 may each include a wheel radius, and the wheel radii may each be substantially similar to, or the same as, each other. For example, the first wheel 120 may include a first wheel radius 120a and the second wheel 125 may include a second wheel radius 125a. The first wheel radius 120a and the second wheel radius 125a may be substantially similar to, or the same as, each other. With the wheel radii substantially similar to, or the same as, each other, the wheels of the animal enrichment device 100 may contact a ground surface and support the core 105 and other elements of the animal enrichment device 100 discussed herein. Additionally, a user, such as an animal owner or an animal, may engage with the animal enrichment device 100 and cause the animal enrichment device 100 to move from a first location to a second location by causing the wheels of the animal enrichment device 100 to rotate and moving the device 100 along a surface in the direction of the rotation.

The animal enrichment device 100 may include a delivery device mount 130. For example, the animal enrichment device 100 may be structured to include any number of delivery device mounts 130, such as one delivery device mount 130, four delivery device mounts 130, eight delivery device mounts 130, seventeen delivery device mounts 130, and the like.

The delivery device mount 130 may extend from the core 105. For example, the delivery device mount 130 may be fixedly or permanently coupled with the core 105, removably or detachably coupled with the core 105, integrated with the core 105, or the like. In one such example, the delivery device mount 130 may extend from an exterior surface of the core 105. In this example, the core 105 may include an attachment region or surface, the delivery device mount 130 may include an attachment region or surface, and the attachment regions or surfaces of the core 105 and the delivery device mount 130 may removably or permanently couple with each other. For example, the attachment regions or surfaces may include a snap fit connection, magnets, hook and loop, and/or other configurations known in the art. In another example, the delivery device mount 130 may be integrated with the core 105 and extend from the exterior surface of the core 105. In such an example, the exterior surface of the core 105 may be flush with an exterior surface of the delivery device mount 130, e.g., the exterior surfaces of the delivery device mount 130 and the core 105 may comprise a single unitary surface. In some examples, the delivery device mount 130 may extend through the center 105a of the core 105, as depicted in FIG. 1C. For example, the core 105 may include an internal cavity 165 that may receive the delivery device mount 130, e.g., the delivery device mount 130 may extend through the internal cavity 165 of the core 105. In this example, the delivery device mount 130 may include a first end 130a and a second end 130b opposite each other, and the first end 130a and the second end 130b of the delivery device mount 130 may each define a bore 135 and may each extend outward from the core 105.

The animal enrichment device 100 may further define a bore 135. For example, the animal enrichment device 100 may be structured to include any number of bores 135, such as one bore 135, five bores 135, eight bores 135, sixteen bores 135, and the like. The bore 135 may be defined by the core 105. The bore 135 may extend through a thickness of the core 105. In this example, the animal enrichment device 100 may be structured such that the delivery device mount 130 is not included. In other examples, the bore 135 may be defined by the delivery device mount 130, as depicted in FIG. 1A, among other examples. In one such example, the bore 135 may extend through a thickness of the delivery device mount 130.

The animal enrichment device 100 may include an engagement device 140, as depicted in FIGS. 1A and 6. The engagement device 140 may include a central portion 605. The central portion 605 may be a variety of shapes, such as a cuboid, a cylinder, or the like. The central portion 605 may include a central portion length 605a, or radius 605a in examples where the central portion 605 comprises a cylindrical, substantially cylindrical, or even generally cylindrical shape. The engagement device 140 may include a rim or ridge 610. The rim 610 may extend from the central portion 605. The rim 610 may be a variety of shapes, such as a cuboid, a cylinder, or the like. The rim 610 may include a rim length 610a, or radius 610a in examples with the rim 610 has a circular shape. The rim radius 610a may be greater than or equal to the central portion radius 605a. With the rim radius 610a greater than the central portion radius 605a, the user, such as a hog, may engage with the rim 610. For example, a hog may contact the rim 610 with a user object, such as a snout, mouth, and the like. The user may cause the animal enrichment device 100 to move from the first location to the second location by engaging the engagement device 140 and causing the wheels of the animal enrichment device 100 to rotate. The engagement device 140 may be structured to include any number of rims 610, such as one rim 610, four rims 610, eight rims 610, seventeen rims 610, and the like. For example, the engagement device 140 may include two rims 610, as depicted in FIG. 6 among others. In other examples, a rim 610 or a plurality of rims 610 may extend across a portion, e.g., an entire portion, of the length of the central portion 605.

The engagement device 140 may extend from the core 105, e.g., between the first portion 110 and the second portion 115. For example, the engagement device 140 may be fixedly or permanently coupled with the core 105, removably or detachably coupled with the core 105, integrated with the core 105, or the like. In some examples, the central portion 605 of the engagement device 140 may extend from the core 105, e.g., between the first portion 110 and the second portion 115. For example, the central portion 605 may be fixedly or permanently coupled with the core 105, removably or detachably coupled with the core 105, integrated with the core 105, or the like.

In the example with the engagement device 140, e.g., the central portion 605 of the engagement device 140, fixedly or permanently coupled with the core 105, the engagement device 140 may be a separate component that is adhered to the core 105 such that the engagement device 140 is inhibited from being removed from the core 105. In the example with the engagement device 140, e.g., the central portion 605 of the engagement device 140, removably coupled with the core 105, the engagement device 140 may be a separate component that is attached to the core 105 such that the engagement device 140 is not inhibited from being removed from the core 105. For example, the engagement device 140 may include a slit extending longitudinally through the central portion 605 and the central portion 605 may wrap around the core 105. The central portion 605 may include attachment means, such as a snap fit buckle, belt like buckle, magnets, hook and loop, and/or other configurations known in the art. In the example with the engagement device 140, e.g., the central portion 605 of the engagement device 140, integrated with the core 105, the animal enrichment device 100 may be structured such that the engagement device 140 is not a separate component, but instead is extends directly from and is flush with the core 105 and the engagement device 140 is inhibited from being removed from the core 105. An example of a removably or permanently coupled engagement device 140a as well as an example of an integrated engagement device 140b are depicted in FIG. 1A, among other figures.

In examples of the animal enrichment device 100 in which more than the first wheel 120 and the second wheel 125 are included, e.g., the animal enrichment device 100 may include a third wheel 160, which may include a third wheel radius 160a. The third wheel radius 160a may be substantially similar to, or the same as, the first wheel radius 120a and/or the second wheel radius 125a.

In these examples, the core 105 may include a first core and the animal enrichment device 100 may include additional cores, such as a second core 145. The second core 145 may include a center 145a, such as a center point or center line. The first core 105 and the second core 145 may be similar to, or the same as, (e.g., integrated with) each other as a single unitary core. Additionally, a longitudinal axis of the first core 105 may be substantially aligned with a longitudinal axis of the second core 145, e.g., a single longitudinal axis of the animal enrichment device 100 may extend through or between the cores, such as the first core 105 and the second core 145. The second core 145 may include a first end 150 or portion 150 and a second end 155 or portion 155. The first end 150 and the second end 155 may be opposite each other. The second wheel 125 may extend from a location proximal the first end 150 of the second core 145, e.g., a location distal the second end 155 of the second core 145. The third wheel 160 may extend from a location proximal the second end 155 of the second core 145, e.g., a location distal the first end 150 of the core second core 145.

FIG. 2 depicts a side or cross-sectional view of an example of a wheel hub 200 of the animal enrichment device 100. The wheel hub 200 may include the wheel 205. The wheel 205 may be similar to, or the same as, the first wheel 120, the second wheel 125, and/or the third wheel 160. For example, the first wheel 120, the second wheel 125, and/or the third wheel 160 may include elements or features that are similar to, or the same as, the elements or features of the wheel 205. The wheel 205 may include a reinforcement portion 215. For example, wheel 205 may include a plurality of the reinforcement portions 215 extending around and from a center point of the wheel 205. The reinforcement portions 215 may include a denser material or a different material than the rest of the core 105. The material of the reinforcement portions 215 may inhibit wear and tear of the animal enrichment device 100. For example, a user such as an animal, may engage with and bounce the animal enrichment device 100, and the reinforcement portions 215 may inhibit the wheel 205 from splitting or cracking.

The wheel 205 may include or define an inner cavity 210. The inner cavity 210 may extend through the core 105, e.g., from the first portion 110 to the second portion 115. In this example, the core 105 may be a hollow tube. With the core 105 a hollow tube, the animal enrichment device 100 may weigh less than in examples where the core 105 is structured so as to not include or define the inner cavity 210. For example, the animal enrichment device 100 without the inner cavity 210 may be heavier than the animal enrichment device 100 defining the inner cavity 210. For example, a user may desire an animal enrichment device 100 that is heavier for heavier animals, such as hogs, to engage with, and/or an animal enrichment device 100 that is lighter for lighter animals, such as dogs, to engage with.

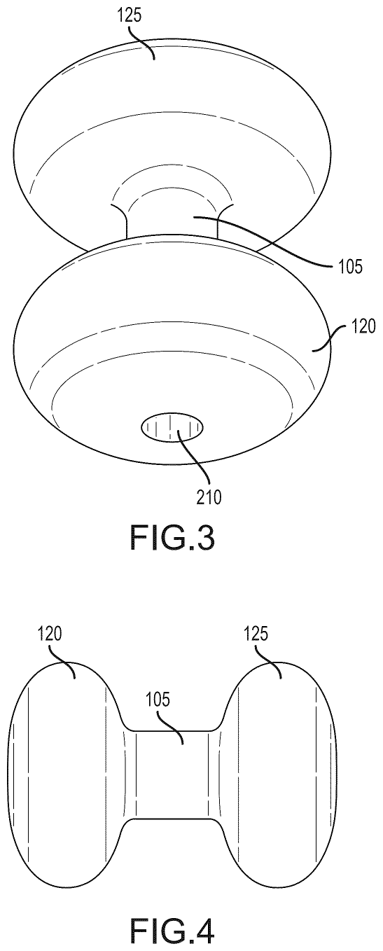

FIGS. 3-5 depict example shapes of the core 105, the first wheel 120, the second wheel 125, and the inner cavity 210. For example, the first wheel 120 and the second wheel 125 may be rounded cylinders. Additionally, FIGS. 3-5 depict example proportions of the core 105, the first wheel 120, the second wheel 125, and the inner cavity 210 with respect to each other. For example, a diameter of the core 105 may be about 50% the diameter of the first wheel 120 and/or the second wheel 125. In another example, a diameter of the inner cavity 210 may be about 5% to 10% the diameter of the first wheel 120 and/or the second wheel 125.

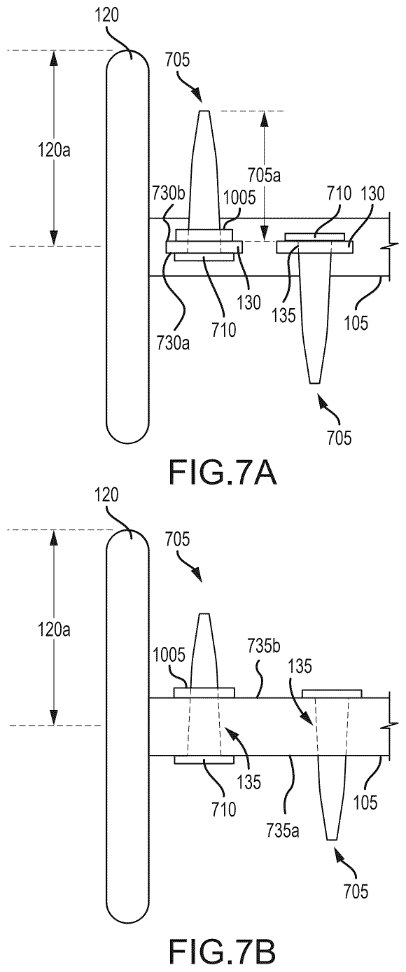

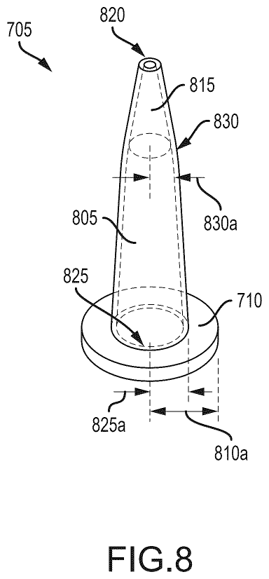

The animal enrichment device 100 of FIG. 1A may further include a delivery device 705, as depicted in FIGS. 7A-10B. The delivery device 705 may be coupled to the animal enrichment device 100 or an integral component of the animal enrichment device 100. The delivery device 705 may include a body 805. The body 805 may include a proximal portion 825 and a distal portion 830. The proximal portion 825 may include a proximal portion length or radius 825a (when the body 805 is generally cylindrical) and the distal portion 830 may include a distal portion length or radius 830a (when the body 805 is generally cylindrical). The distal portion radius 830a may be less than the proximal portion radius 825a, as depicted in FIG. 8. Alternatively, in one or more delivery devices 705, the distal portion radius 830a may be greater than the proximal portion radius 825a. In these examples, the delivery device 705 may be shaped similar to a funnel, cone, or the like. In other examples, the distal portion radius 830a may be substantially equal to the proximal portion radius 825a. In these examples, the delivery device 705 may be shaped similar to a cylinder, cuboid, or the like.

The delivery device 705 may include a base 710. The base 710 may extend radially from the proximal portion 825 of the body 805. The base 710 may comprise a variety of shapes, such as a cuboid, a cylinder, or the like. The base 710 may include a base length 810a, or radius 810a in examples with the base 710 having a cylindrical shape. The base length/radius 810a may be greater than the proximal portion radius 825a and/or the distal portion radius 830a.

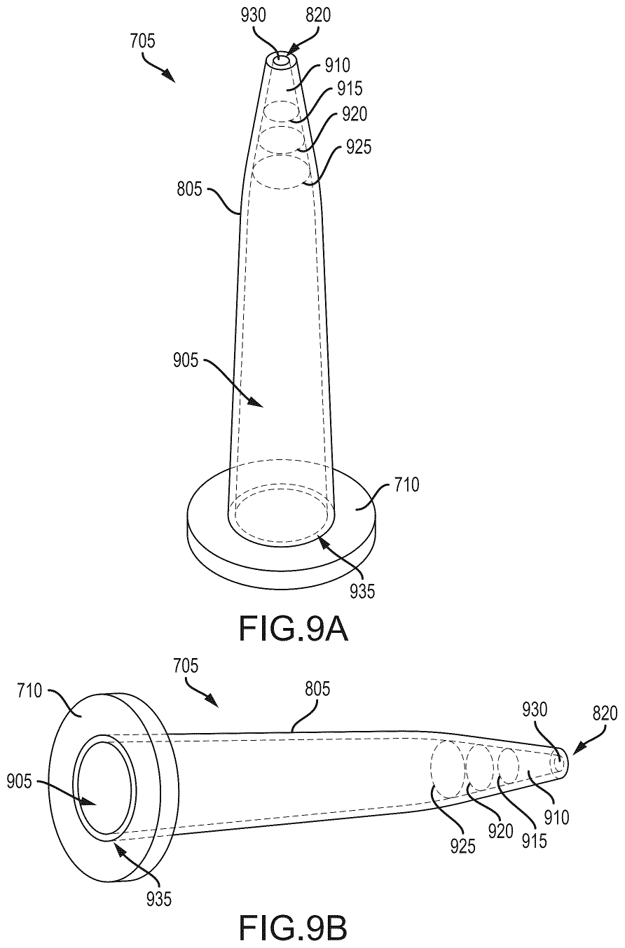

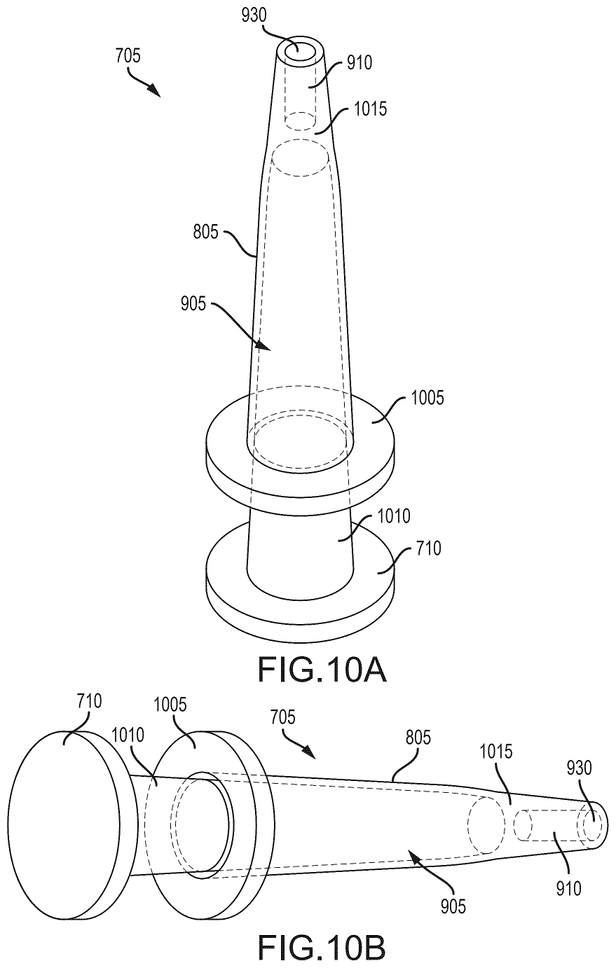

The delivery device 705 may include a tip 815. The tip 815 may comprise the cone-shaped area defined by the dashed lines in FIG. 8 above the body, extending from the distal portion 830 of the body 805 to a delivery end 820, located at the end of the tip 815. As seen in FIGS. 9A-10B, the tip 815 may comprise or define a discharge point 930. The discharge point 930 may be, may include, or may define a hole, a slit, or the like.

The tip 815 may deliver a substance, such as liquid or solid medicine, food, treats, or the like, through the delivery end 820 and/or the discharge point 930. In some examples, the substance may have a low viscosity, such as greater than or equal to about 0.5 centipoise and less than or equal to about 550 centipoise. For example, the substance may be a liquid with a viscosity similar to, or the same as, water, oil, and the like. In other examples, the substance may have a high viscosity, such as greater than or equal to about 550 centipoise and less than or equal to about 30,000 centipoise. For example, the substance may be a liquid with a viscosity similar to, or the same as, molasses, honey, peanut butter, and the like. In other examples, the substance may be a solid, such as an animal treat, a carrot, or the like.

The substance may be extracted from a delivery cavity 910 through the discharge point 930 by an animal (which may be referred to herein as a “user”), such as a hog, a horse, a dog, a cat, or the like. The delivery device 705 may include or define the delivery cavity 910, as depicted in FIGS. 9A-10B. The delivery cavity 910 may comprise one or more of multiple depths 915, 920, 925, as measured from the delivery end 820. The substance may be loaded or otherwise inserted into the delivery cavity 910. For example, the substance may be loaded into the delivery cavity 910 through the delivery end 820. The delivery cavity 910 may hold the substance, e.g., until a user extracts the substance from the delivery cavity 910.

With the discharge point 930 as a slit, the slit may transition from a closed position to an open position in response to a pressure applied to the discharge point 930 and/or the tip 815. For example, a pinching pressure may be applied to the discharge point 930 and/or the tip 815 to transition the slit from the closed position to the open position. For example, the slit may include a longitudinal axis and a first pressure may be applied against an outer surface of the discharge point 930 and/or the tip 815 in a direction substantially parallel, or in line with, the longitudinal axis of the slit, and a second pressure may be applied against an outer surface of the discharge point 930 and/or the tip 815 in a direction opposite the first pressure. The substance may evacuate the delivery cavity 910 through the slit with the slit in the open position. Embodiments are contemplated where the user may engage with the delivery end 820 and manipulate the slit from the closed position to the open position and suck the substance from the delivery cavity 910 out of the delivery device 705. In other examples with the discharge point 930 as a hole, the user may engage with the delivery end 820 and squeeze, suck, or push the substance from the delivery cavity 910 out of the delivery device 705, or insert a user object, such as a tongue or paw directly into the delivery cavity 910 and scoop or otherwise extract the substance from the delivery cavity 910.

The delivery device 705 may include or define a hollow core 905. For example, the body 805 may define the hollow core 905. In some examples, the delivery cavity 910 and the hollow core 905 may be a single cavity. For example, the delivery device 705 may be a hollow structure. The delivery device 705 may include or define an opening 935, as depicted in FIG. 9B among others. The substance may be inserted, distributed, delivered, loaded, or the like into the delivery cavity 910 through the opening 935, the hollow core 905, and/or the tip 815.

As seen in FIGS. 8-9B, the opening 935 may be defined at the proximal portion 825 of the delivery device 705. The opening 935 may expose the hollow core 905 to an environment external the delivery device 705. In these embodiments, an animal owner or caretaker may load the substance into the delivery cavity 910 through the hollow core 905. For example, the user may insert a needle of a syringe loaded with the substance through the hollow core 905, a solid portion 1015 of the delivery device 705, e.g., positioned between the hollow core 905 and the delivery cavity 910, and/or into the delivery cavity 910. The user may then push the substance from the syringe into and the delivery cavity 910, loading the delivery cavity 910 with the substance. In some examples, the opening 935 may be closed or covered. For example, the animal enrichment device 100 may include a removable or at least partially detachable covering, cap, lid, plug, and/or other configurations known in the art. In another example, the opening 935 may include a deformable material and may define a slit that is similar to, or the same as, the slit of the discharge point 930. Additionally, the user may load a substance into the hollow core 905. For example, the user may load a first substance into the delivery cavity 910 and a second substance that may be different than or the same as the first substance into the hollow core 905. In this example, the user, such as an animal, may engage with the delivery device 705 and may extract substances from the opening 935 and/or the delivery end 820.

In other examples, the delivery device 705 may be structured such that the opening 935 is not defined or included, as depicted in FIGS. 10A-B. In these examples, the hollow core 905 may not be exposed to the environment external the delivery device 705. In this example, the user may insert a needle of a syringe loaded with the substance through a first solid portion 1010 of the delivery device 705, e.g., positioned between the base 710 and the hollow core 905; the hollow core 905; a second solid portion 1015 of the delivery device 705, e.g., positioned between the hollow core 905 and the delivery cavity 910; and/or into the delivery cavity 910. The user may then push the substance from the syringe into and the delivery cavity 910, loading the delivery cavity 910 with the substance. It is contemplated that the syringe or other substance loading device may pierce or otherwise travel through one or more solid or substantially solid portions and/or surfaces of the device 705 to deliver the substance to the cavity 910.

Alternatively, the animal enrichment device 100 may be structured such that the hollow core 905 is not included or defined. For example, the delivery device 705 may include at least a partially solid core. A delivery device 705 having a core that is at least partially solid, may be heavier than the delivery device 705 defining the hollow core 905. For example, a user may desire a delivery device 705 that is heavier for heavier animals, such as hogs, to engage with, and/or a delivery device 705 that is lighter for lighter animals, such as dogs, to engage with.

The delivery device 705 may couple, e.g., directly or indirectly, with the core 105. For example, the delivery device 705 may be fixedly or permanently coupled with the core 105, removably or detachably coupled with the core 105, integrated with the core 105, or the like. In examples with the delivery device 705 integrated with the core 105, the delivery device 705 may extend from the exterior surface of the core 105. For example, the exterior surface of the core 105 may be flush with an exterior surface of the delivery device 705, e.g., the exterior surfaces of the delivery device 705 and the core 105 may be similar to, or the same as, each other. In this example, the delivery device 705 may be structured such that the base 710, opening 935 and/or the hollow core 905 are not included or defined. For example, the substance may be loaded into the delivery cavity 910 of the tip 815 via the delivery end 820 and/or through a thickness of the tip 815 defined between the exterior surface of the tip 815 and the delivery cavity 910. In other examples, the delivery device 705 may be integrated with the core 105 and define the hollow core 905. For example, the delivery device 705 may extend from the core 105 and the opening 935 may be defined by the core 105.

In examples with the delivery device 705 fixedly or permanently coupled with the core 105, the delivery device 705 may be a separate component that is adhered, e.g., directly or indirectly, to the core 105, such that the delivery device 705 is inhibited from being removed from the core 105. In examples with the delivery device 705 removably coupled with the core 105, the delivery device 705 may comprise one or more separate components that are attached, e.g., directly or indirectly, to the core 105 such that the delivery device 705 is not inhibited from being removed from the core 105. In these examples, the delivery device 705 may be removed from the core 105, cleaned or sanitized, and then reattached to the delivery device 705. In these examples, the delivery device 705 may be removed from the core 105, loaded with the substance, and then reattached to the delivery device 705.

In examples with the delivery device 705 directly coupled, e.g., removably or fixedly, with the core 105, the animal enrichment device 100 may be structured such that the delivery device mount 130 is not included. The body 805 of the delivery device 705 may extend through the bore 135 of the core 105. The delivery device 705 may be structured such that the base 710 of the delivery device 705 is inhibited from extending through the bore 135 and instead the base 710, e.g., an exterior surface of the base 710 extending from the body 805, may abut the core 105. For example, the base length/radius 810a, e.g., a radius of the base 710, may be greater than or equal to a length of the bore 135, e.g., a radius of the bore 135. In this way, the base 710 may couple or secure the body 805 of the delivery device 705 with the core 105. For example, the base 710 may inhibit the delivery device 705 from extending the entire way through the bore 135 and thus inhibit the delivery device 705 from inadvertently being disconnected or uncoupled with the core 105.

In examples with the delivery device 705 indirectly coupled, e.g., removably or fixedly, with the core 105, the animal enrichment device 100 may include the delivery device mount 130. The body 805 of the delivery device 705 may extend through the bore 135 of the delivery device mount 130. The delivery device 705 may be structured such that the base 710 of the delivery device 705 is inhibited from extending through the bore 135 and instead the base 710, e.g., an exterior surface of the base 710 proximally extending from the body 805, may abut the delivery device mount 130, e.g., a first surface 730a of the delivery device mount 130. For example, the base length/radius 810a, e.g., a radius of the base 710, may be greater than or equal to a length of the bore 135, e.g., a radius of the bore 135. In this way, the base 710 may couple or secure the body 805 of the delivery device 705 with the delivery device mount 130. For example, the base 710 may inhibit the delivery device 705 from extending entirely through the bore 135 and thus inhibit the delivery device 705 from inadvertently being disconnected or uncoupled with the delivery device mount 130. In other examples, the proximal portion radius 825a and a length of the bore 135, e.g., a radius of the bore 135, may be sized so an exterior surface of the body 805 is flush with an inner surface of the bore 135.

The delivery device 705 may include a ring 1005, as depicted in FIG. 10A. The ring 1005 may include a shape similar to, or the same as, the base 710. For example, a length of the ring 1005 may be similar to, or the same as, the base length/radius 810a. In other examples, the length/radius of the ring 1005 may be less than, the same as, or greater than the base length/radius 810a. In some embodiments, the ring 1005 may be an integral component of the delivery device 705. In these embodiments, the ring 1005 may extend through the bore 135. For example, with the delivery device 705 integrated or directly coupled, removably or fixedly, with the core 105, the ring 1005 may extend through the bore 135 of the core 105, as depicted in FIG. 7B. In the examples with the delivery device 705 indirectly coupled with the core 105, the ring 1005 may extend through the bore 135 of the delivery device mount 130. In other embodiments, the ring 1005 may couple with the delivery device 705. In these embodiments, the tip 815 and at least a portion of the body 805 of the delivery device 705 may extend through the bore 135, e.g., of the core 105 or of the delivery device mount 130 depending on the embodiment, and the ring 1005 may slide over the tip 815 and the portion of the body 805 of the delivery device 705 and couple to the delivery device 705. The ring 1005 may couple to the delivery device 705 via a friction fit, a snap fit, threaded securement, and/or other configurations known in the art.

The ring 1005 may contribute to the securement of the delivery device 705 to the core 105 or to the delivery device mount 130, depending on the embodiment, or inhibit an unintended decoupling of the delivery device 705 from the core 105 or from the delivery device mount 130. For example, the ring 1005 may “lock”, e.g., removably or permanently, the delivery device 705 to the core 105 or to the delivery device mount 130, depending on the embodiment. In this way, the ring 1005 may be referred to herein as a locking device.

In examples with the delivery device 705 directly coupled, e.g., removably or fixedly, with the core 105, the ring 1005 may abut the core 105. For example, the exterior surface of the base 710 extending from the body 805, may abut a first surface 735a of the core 105, the core 105 may include a second surface 735b opposite the first surface 735a, and an exterior surface of the ring 1005 may abut the second surface 735b. For example, with the delivery device 705 coupled, e.g., removably or fixedly, with the core 105, the core 105 may be positioned between the base 710 of the delivery device 705 and the ring 1005 of the delivery device 705.

In examples with the delivery device 705 indirectly coupled, e.g., removably or fixedly, with the core 105, the ring 1005 may abut the delivery device mount 130. For example, the exterior surface of the base 710 extending from the body 805, may abut the first surface 730a of the delivery device mount 130, the delivery device mount 130 may include a second surface 730b opposite the first surface of the delivery device mount 130, and an exterior surface of the ring 1005 may abut the second surface 730b of the delivery device mount 130, as depicted in FIG. 7A. For example, with the delivery device 705 coupled, e.g., removably or fixedly, with the delivery device mount 130, the delivery device mount 130 may be positioned between the base 710 of the delivery device 705 and the ring 1005 of the delivery device 705.

FIGS. 7A-7B depict examples of delivery devices 705 coupled with the core 105. FIG. 7A depicts an example of the delivery devices 705 coupled with the core 105 via the delivery device mounts 130. For example, the animal enrichment device 100 is depicted in an orientation rotated 90 degrees from the orientation of the animal enrichment device 100 depicted in FIG. 1A. The removably or permanently coupled engagement device 140a is not depicted in FIG. 7A for clarity. FIG. 7B depicts an example of the delivery devices 705 coupled with the core 105 directly, e.g., the animal enrichment device 100 is structured to not include the delivery device mounts 130. For example, the animal enrichment device 100 is depicted in an orientation rotated 90 degrees from the orientation of the animal enrichment device 100 depicted in FIG. 1B. The removably or permanently coupled engagement device 140a is not depicted in FIG. 7B for clarity

The delivery device 705 may include a delivery device length 705a. The delivery device length 705a may extend between the proximal portion 825 and the delivery end 820 of the delivery device 705. With the delivery device 705 coupled with the core 105, the delivery device length 705a may extend from the center 105a of the core 105 to the delivery end 820 of the delivery device 705. The delivery device length 705a may be less than the wheel radii, such as the first wheel radius 120a depicted in FIG. 7A among other figures. For example, the delivery device length 705 a may be greater than or equal to about 10% and less than or equal to about 90% of the first wheel radius 120 a, the second wheel radius 125 a, and/or the third wheel radius 160a. For example, a distance from the center 105a of the core 105 to the delivery end 820 of the delivery device 705 may be less than the wheel radii, such as first wheel radius 120a, the second wheel radius 125a, and/or the third wheel radius 160a.

With the delivery device length 705a less than the wheel radii, such as first wheel radius 120a, the second wheel radius 125a, and/or the third wheel radius 160a, sanitation of the animal enrichment device 100 may be promoted or increased, as opposed to the delivery device length 705a greater than or equal to the wheel radii. For example, the user, such as an animal may move the animal enrichment device 100 across a ground surface and the delivery device 705 and/or the engagement device 140, each of which the user may engage with, may be inhibited from contacting the ground surface. In this way, dirt or other substances from the ground surface may be inhibited from contacting, adhering to, or contaminating the delivery device 705 and/or the engagement device 140.

In some examples, multiple deliver devices 705 may be coupled with the first core 105 and/or additional cores. For example, a second delivery device, which may be similar to, or the same as, the delivery device 705, may couple with the second core 145. The second delivery device may include a tip, which may be similar to, or the same as, the tip 815. With the tip of the second delivery device coupled directly or indirectly with the second core 145, the tip of the second delivery device may extend less than the wheel radii, such as the first wheel radius 120a, the second wheel radius 125a, and/or the third wheel radius 160a. For example, the tip of the second delivery device may include a delivery end, and a distance from the center 145a of the second core 145 to the delivery end of the tip of the second delivery device is less than the wheel radii, such as the first wheel radius 120a, the second wheel radius 125a, and/or the third wheel radius 160a.

Any of the features, components, and/or parts, including the arrangements and configurations thereof shown in FIGS. 1A-10 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 1A-10B.

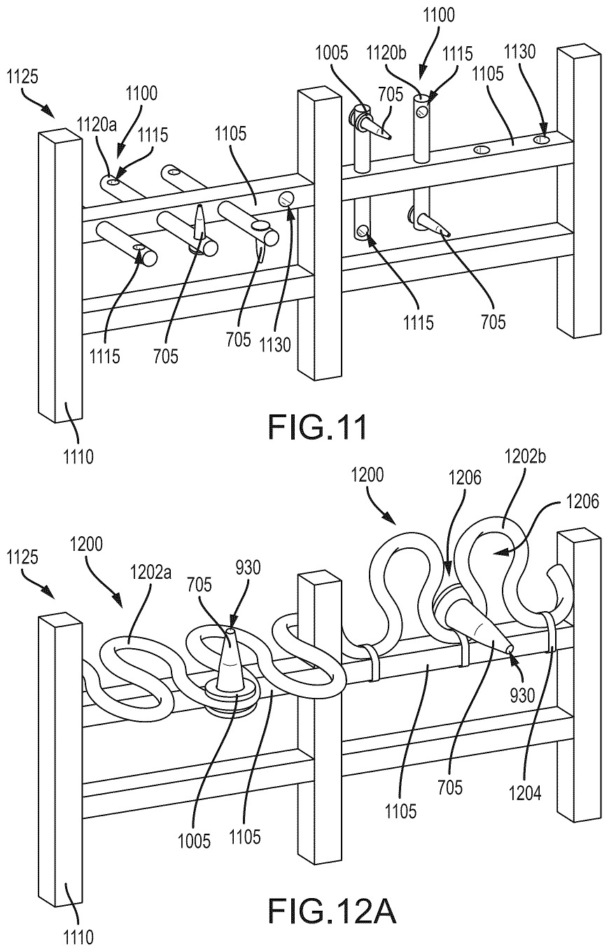

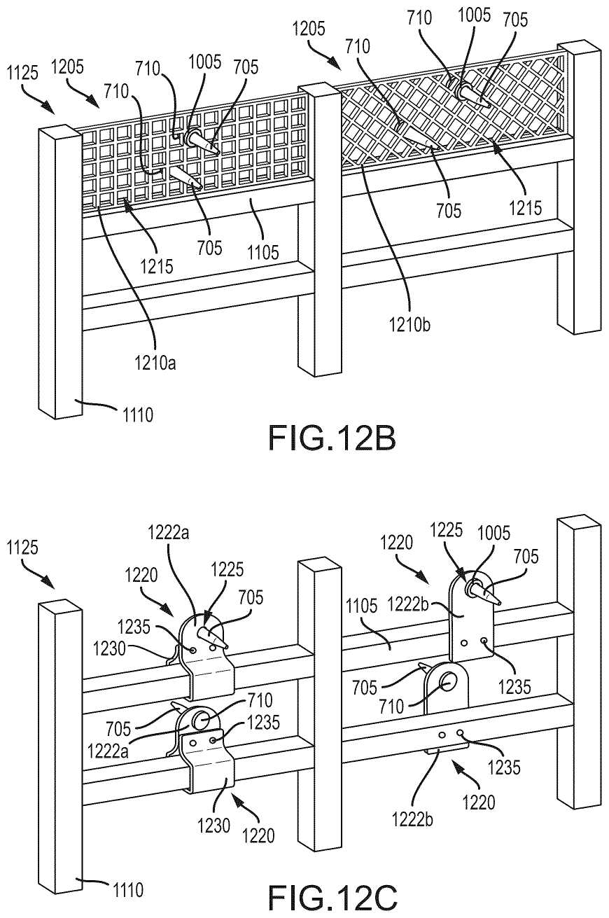

FIGS. 11-12C depict examples of animal enrichment devices that may couple with a structure 1125, such as a fence, a wall, and/or other configurations known in the art. FIG. 11 depicts an animal enrichment device 1100 integrated with the structure 1125. The term “integrated” as used with respect to the animal enrichment device 1100 shown in FIG. 11 means the structure 1125 may include coupling features that assist in the coupling of the animal enrichment device 1100 and the structure 1125. FIGS. 12A-12C depict animal enrichment devices 1200, 1205, 1220, respectively, fixedly or removably coupled with the structure 1125. In these embodiments, coupling features may not be included in or by the structure 1125. The animal enrichment devices 1100, 1200, 1205, 1220 may be coupled between and/or to structural posts 1110, such as fence posts 1110, and between and/or to structural beams, such as fence rails 1105. The animal enrichment devices 1100, 1200, 1205, 1220 may include a hard material or a soft material. For example, the animal enrichment device 1100 may include hard or substantially rigid materials, such as galvanized steel, melamine plastic, polymethyl methacrylate, polycarbonate, High-Density Polyethylene, Polyvinyl Chloride, Acrylonitrile Butadiene Styrene, Polytetrafluoroethylene, High Impact Polystyrene, metal, and the like. For example, the animal enrichment device 1100 may include soft, elastomeric, or flexible materials, such as rubber, elastin, nylon, lycra, cartilage, silicone, and the like.

The animal enrichment device 1100 may include a delivery device mount, which may be positioned or oriented at any angle relative to the fence rails 1105. For example, the animal enrichment device 1100 may include a substantially horizontal delivery device mount 1120a and/or a substantially vertical delivery device mount 1120b. The fence rails 1105 may include or define a structural bore 1130. The structural bores 1130 may extend through a thickness of the fence rails 1105 at various angles. The delivery device mounts 1120a, 1120b may extend through the structural bores 1130, which may define the angle at which the delivery device mounts 1120a, 1120b are oriented relative to the fence rails 1105. The delivery device mounts 1120a, 1120b may removably or fixedly couple with the fence rails 1105. For example, the delivery device mounts 1120a, 1120b may be removably coupled with the fence rails 1105 via a via a friction fit, a snap fit, threaded securement, and/or other configurations known in the art. In other examples, the delivery device mounts 1120a, 1120b may be fixedly coupled with the fence rails 1105 via an adhesive, a screw type fastener, and/or other configurations known in the art.

The delivery device mounts 1120a, 1120b may include or define a bore 1115. The bore 1115 may be similar to, or the same as, the bore 135. For example, the delivery device 705 may be coupled with either delivery device mount, e.g., the delivery device mount 1120a or the delivery device mount 1120b, via the bore 1115. For example, the delivery device 705 may extend through the bore 1115, and the base 710 of the delivery device 705 may abut a surface of the respective delivery device mount, e.g., the delivery device mount 1120a or the delivery device mount 1120b.

In the example depicted in FIG. 12A, the animal enrichment device 1200 may include a delivery device mount, which may be positioned or oriented at any angle relative to the fence rails 1105. For example, the animal enrichment device 1200 may include a substantially horizontal delivery device mount 1202a and/or a substantially vertical delivery device mount 1202b. The delivery device mounts 1202a, 1202b may couple with the structure 1125. For example, the delivery device mounts 1202a, 1202b may wrap or weave around the structural posts 1110 and/or the fence rails 1105 to couple with the structure 1125. In FIG. 12A, the substantially horizontal delivery device mount 1202a is depicted wrapping or weaving around the structural posts 1110. In other examples, the animal enrichment device 1200 may include a fastener 1204. In these examples, the fastener 1204 may removably or fixedly couple the delivery device mounts 1202a, 1202b with the structure 1125. For example, the fastener 1204 may be a strap fastened around the fence rails 1105 and the delivery device mounts 1202a, 1202b. In other examples, the fastener 1204 may be an adhesive disposed between the fence rails 1105 and the delivery device mounts 1202a, 1202b. In FIG. 12A, the fastener 1204 is depicted as a strap wrapped around the substantially vertical delivery device mount 1202b and the fence rail 1105.

The delivery device mounts 1202a, 1202b may define spaces or gaps 1206. The gaps 1206 may be between segments of the delivery device mounts 1202a, 1202b and/or between the delivery device mounts 1202a, 1202b and the structure 1125. The gaps 1206 may be similar to, or the same as, the bore 135. For example, the delivery device 705 may be coupled with the structure 1125 and/or the animal enrichment device 1200 via the gap defined between the structure 1125 and the animal enrichment device 1200. For example, the delivery device 705 may extend through the gap defined between the structure 1125 and the animal enrichment device 1200, and the base 710 of the delivery device 705 may abut a surface of the animal enrichment device 1200.

In the example depicted in FIG. 12B, the animal enrichment device 1205 may include a delivery device mount. For example, the delivery device mount may be a grid-type delivery device mount 1210a or a lattice-type delivery device mount 1210b. The delivery device mounts 1210a, 1210b may be removably or fixedly coupled with the structure 1125. In other embodiments, the structure 1125 may comprise a grid-type or lattice-type structure, e.g., a fence railing may comprise such a structure. The delivery device mounts 1210a, 1210b may include or define a bore 1215. The bore 1215 may be similar to, or the same as, the bore 135. For example, the delivery device 705 may couple with either delivery device mount, e.g., the grid-type delivery device mount 1210a or the lattice-type delivery device mount 1210b, via the bore 1215. For example, the delivery device 705 may extend through the bore 1215, and the base 710 of the delivery device 705 may abut a surface of the respective delivery device mount, e.g., the grid-type delivery device mount 1210a or the lattice-type delivery device mount 1210b. In some examples, the bore 1215 may be circular, square, triangular, and/or other configurations known in the art. For example, the bore 1215 may be a 2-inch by 2-inch square, a 2-inch by 4-inch square, a 4-inch by 4-inch square, or the like. The width of the delivery device 705 may be sized accordingly, e.g., to extend through the bore 1215. For example, the width of the delivery device 705 may be greater than or equal to about 3 inches and less than or equal to about 6 inches. For example, the width of the delivery device 705 may be about 4 inches.

In the example depicted in FIG. 12C, the animal enrichment device 1220 may include a delivery device mount, which may couple with the structure 1125. For example, the animal enrichment device 1220 may include a passively couplable delivery device mount 1222a and/or an actively couplable delivery device mount 1222b. In these examples, the phrase “passively couplable” means the delivery device mount 1222a may be attached or secured to the structure 1125 indirectly, e.g., without penetrating or manipulating a surface of the structure 1125; and the phrase “actively couplable” means the delivery device mount 1222b may be attached or secured to the structure 1125 directly, e.g., by penetrating or manipulating a surface of the structure 1125.

The animal enrichment device 1220 may include a fastener 1235. The fastener 1235 may be a screw-type fastener, a button system, a hook and loop system, an adhesive, and/or other configurations known in the art. The fastener 1235 may couple either delivery device mount, e.g., the passively couplable delivery device mount 1222a or the actively couplable delivery device mount 1222b, with the structure 1125. The passively couplable delivery device mount 1222a may include a securement flap 1230. The securement flap 1230 may wrap around the fence rail 1105 and secure or attach to a portion of the passively couplable delivery device mount 1222a via the fastener 1235. In other examples, the fastener 1235 directly couple the actively couplable delivery device mount 1222b with the structure 1125. For example, as depicted in FIG. 12C, the fastener 1235 may be a screw type fastener extending through a thickness of the actively couplable delivery device mount 1222b and a thickness of the fence rail 1105.

The delivery device mount, e.g., the passively couplable delivery device mount 1222a and/or the actively couplable delivery device mount 1222b, may include or define a bore 1225. The bore 1225 may be similar to, or the same as, the bore 135. For example, the delivery device 705 may couple with the delivery device mount, e.g., the passively couplable delivery device mount 1222a and/or the actively couplable delivery device mount 1222b, via the bore 1225. For example, the delivery device 705 may extend through the bore 1225, and the base 710 of the delivery device 705 may abut a surface of the delivery device mount, e.g., the passively couplable delivery device mount 1222a and/or the actively couplable delivery device mount 1222b.

Any of the features, components, and/or parts, including the arrangements and configurations thereof shown in FIGS. 11-12C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 11-12C.

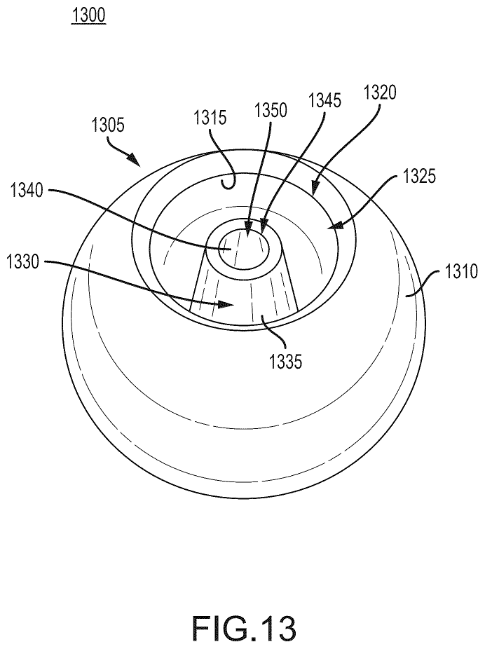

FIGS. 13-20 depict examples of an animal enrichment device 1300. The animal enrichment device 1300 may include a hard material or a soft material. For example, the animal enrichment device 1300 may include hard or substantially rigid materials, such as galvanized steel, melamine plastic, polymethyl methacrylate, polycarbonate, High-Density Polyethylene, Polyvinyl Chloride, Acrylonitrile Butadiene Styrene, Polytetrafluoroethylene, High Impact Polystyrene, metal, and the like. For example, the animal enrichment device 1300 may include soft, elastomeric, or flexible materials, such as rubber, elastin, nylon, lycra, cartilage, silicone, and the like.

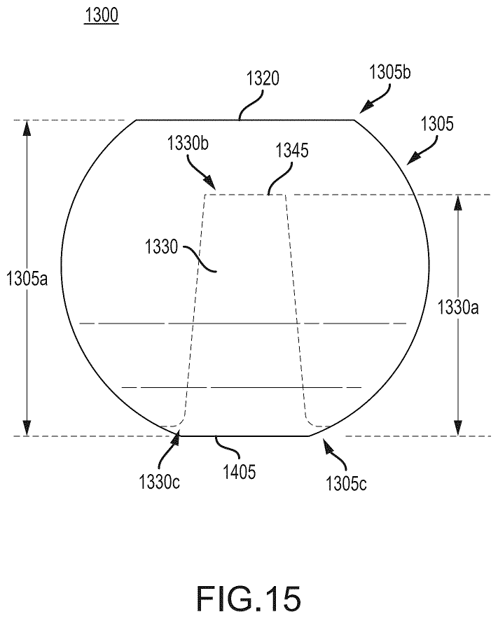

As depicted in FIG. 13, the animal enrichment device 1300 may include a body 1305. The body 1305 may include an exterior surface 1310 and an interior surface 1315. The exterior surface 1310 and the interior surface 1315 may substantially oppose each other. As seen in FIG. 15, the body 1305 may include a body length 1305a, a first body end 1305b, and second body end 1305c. The first body end 1305b and the second body end 1305c may be on opposing ends of the body 1305. The first body end 1305b may include a top end or surface of the body 1305 and the second body end 1305c may include a bottom end or surface of the body 1305, e.g., the animal enrichment device 1300 depicted in FIG. 15 comprises such an orientation. It is contemplated that each of these ends may also be referred to herein as a portion. The body length 1305a may be defined between the first body end 1305b and the second body end 1305c.

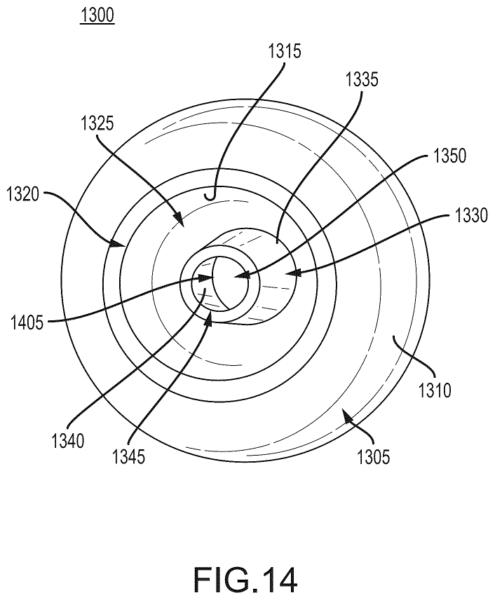

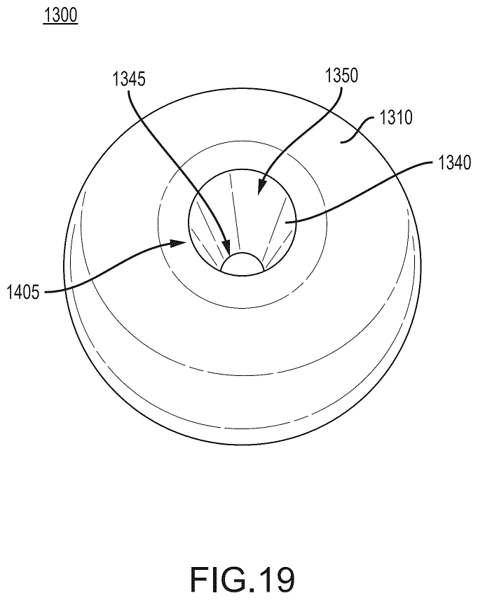

As seen in FIGS. 13 and 14, the animal enrichment device 1300 may include a core 1330. The core 1330 may include an exterior surface 1335 and an interior surface 1340. The exterior surface 1335 and the interior surface 1340 may be opposite each other. The core 1330 may extend from the interior surface 1315 and/or the exterior surface 1310 of the body 1305. For example as depicted in FIGS. 14 and 19, the interior surface 1315 of body 1305 may transition into or otherwise become the exterior surface 1335 of the core 1330. In this example, the interior surface 1315 of body 1305 may be integrated to the exterior surface 1335 of the core 1330. Additionally, the exterior surface 1310 of body 1305 may transition into or otherwise become the interior surface 1340 of the core 1330. In this example, the exterior surface 1310 of body 1305 maybe integrated to the interior surface 1340 of the core 1330.

The core 1330 may include a core length 1330a, a first core end 1330b, and a second core end 1330c, as depicted in FIG. 15. The exterior surface 1330 of the core 1330 is depicted in dashed lines in FIG. 15. The first core end 1330b and the second core end 1330c may be opposite each other. For example, the first core end 1330b may include a top end of the core 1330 and the second core end 1330c may include a bottom end of the core 1330, e.g., in the orientation of the animal enrichment device 1300 depicted in FIG. 15. The core length 1330a may be defined between the first core end 1330b and the second core end 1330c.

The core length 1330a may be less than or equal to the body length 1305a. For example, the core length 1330 a may comprise a length from about 20% to about 80% of the body length 1305 a. For example, the core length 1330 a may be about 74% of the body length 1305 a. In some examples, the core length 1330 a may be greater than or equal to about 3 centimeters and less than or equal to about 11 centimeters, and the body length 1305 a may be greater than or equal to about 5 centimeters and less than or equal to about 14 centimeters. For example, the core length 1330 a may be about 7 centimeters and the body length 1305 a may be about 9.5 centimeters.

Where the core length 1330a is less than the body length 1305a, the animal enrichment device 1300 may promote enhanced sanitation and cleanliness of the surrounding environment during operation. For example, the structure of the animal enrichment device 1300 may inhibit the first core end 1330b from contacting a ground surface since the body length 1305a may be greater than the core length 1330a. For example, the animal enrichment device 1300 may be structured such that the body 1305, e.g., the exterior surface 1310 of the body 1305, primarily contacts the ground surface.

The animal enrichment device 1300 may include or define an opening, such as a first opening 1320, a second opening 1345, and a third opening 1405. For example, the body 1305 may define the first opening 1320 and the third opening 1405, and the core 1330 may define the second opening 1345. The first opening 1320 may be defined by the body 1305 at the first body end 1305b. For example, the first opening 1320 may be defined by the top portion of the body 1305. The second opening 1345 may be defined by the core 1330 at the first core end 1330b. For example, the second opening 1345 may be defined by the top portion of the core 1330. The third opening 1405 may be defined by the body 1305 and by the core 1330. The third opening 1405 may be defined by the body 1305 at the second body end 1305c. For example, the third opening 1405 may be defined by the bottom end of the body 1305. Additionally, the third opening 1405 may be further defined by the core 1330 at the second core end 1330c. For example, the third opening 1405 may be defined by the bottom portion of the core 1330. In these examples, the second body end 1305c and the second core end 1330c may be integrated to each other.

The first opening 1320 provides access to a body cavity 1325. For example, the first opening 1320 may provide access to an open space extending between the interior surface 1315 of the body 1305 and the exterior surface 1310 of the core 1330.

The second opening 1345 provides access to a core cavity 1350 at the first core end 1330b and is defined by the interior surface 1340 of the core 1330 at the first core end 1330b. The first opening 1320 may also provide access to the core cavity 1350. For example, the core 1330 may be disposed within the body cavity 1325 and a user may access the core cavity 1350 via the first opening 1320 and the second opening 1345.

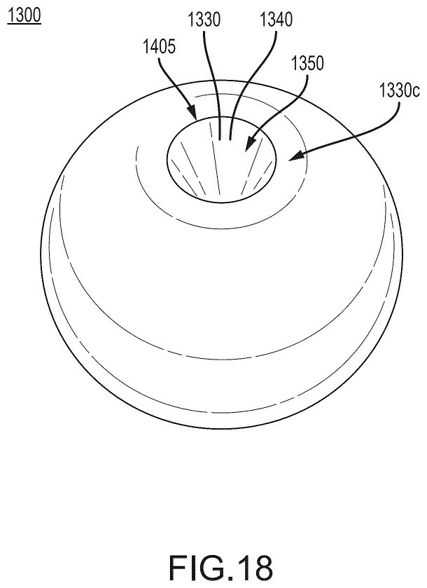

The third opening 1405 also provides access to an interior of the core 1330, e.g., the core cavity 1350, but this access is provided at the second core end 1330c. As seen in FIG. 18, the third opening 1405 is defined by the interior surface 1340 of the core 1330 at the second core end 1330c.

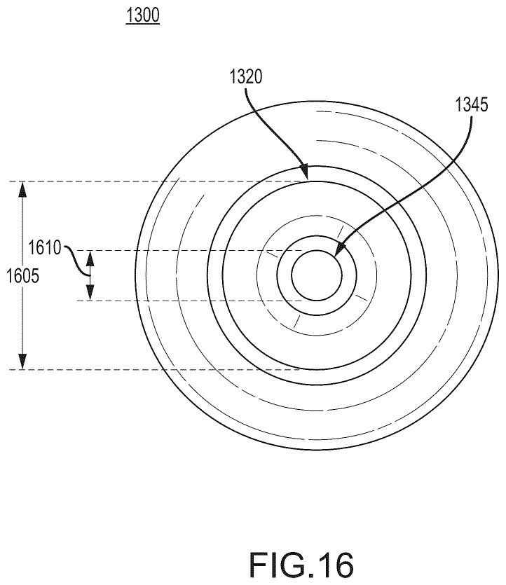

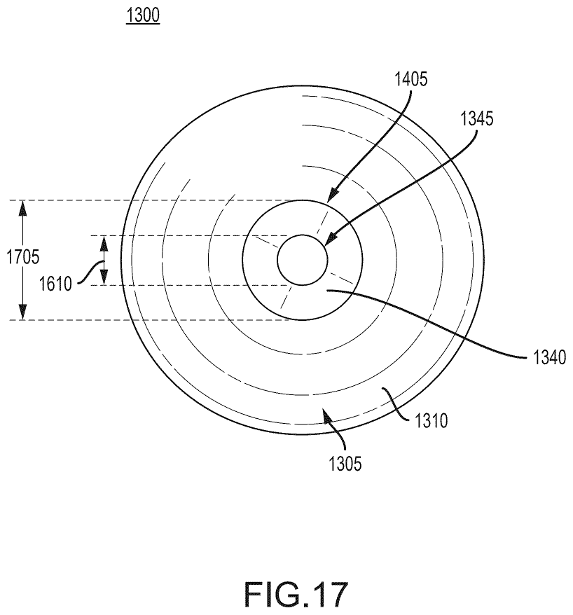

As depicted in FIGS. 16 and 17, the first opening 1320 may include a first opening length 1605 (which may comprise a radius), the second opening 1345 may include a second opening length 1610 (which may comprise a radius), and the third opening 1405 may include a third opening length 1705 (which may comprise a radius). The first opening length 1605 may be greater than or equal to the second opening length 1610. Embodiments may comprise a second opening length 1610 that is: (i) greater than or equal to about 10%, and (ii) less than or equal to about 50%, of the first opening length 1605. In one such embodiment, the second opening length 1610 may be about 30% of the first opening length 1605. Some embodiments may have: (i) a first opening length 1605 greater than or equal to about 3.5 centimeters and less than or equal to about 9.5 centimeters, and (ii) a second opening length 1610 greater than or equal to about 1 centimeter and less than or equal to about 8.5 centimeters. For example, the first opening length 1605 may be about 6.5 centimeters and the second opening length 1610 may be about 2 centimeters.

The third opening length 1705 may also be less than or equal to the first opening length 1605 but may be greater than or equal to the second opening length 1610. For example, (a) the third opening length 1705 may be greater than or equal to about 10% of the first opening length 1605 and less than or equal to about 90% of the first opening length 1605, and (b) the second opening length 1610 may be greater than or equal to about 10% and less than or equal to about 90% of the third opening length 1705. For example, the third opening length 1705 may be about 60% of the first opening length 1605 and the second opening length 1610 may be about 50% of the third opening length 1705. In other examples, the third opening length 1705 may be equal to the first opening length 1605,and the second opening length 1610. It is further contemplated that the third opening length 1705 may comprise a length greater than or equal to about 1 centimeter and less than or equal to about 9.5 centimeters. For example, the first opening length 1605 may be about 6.5 centimeters, the second opening length 1610 may be about 2 centimeters, and third opening length 1705 may be about 4 centimeters. In examples where the first opening 1320 is the largest of the three openings defined by the animal enrichment device 1300, the first opening 1320 may be referred to as a large or the largest body or device opening. In examples where the second opening 1345 is the smallest opening defined by the animal enrichment device 1300, the second opening 1345 may be referred to as a small or the smallest core or device opening.

The animal enrichment device 1300 may include or define at least one hollow portion, such as the body cavity 1325, as depicted in FIG. 13, and the core cavity 1350, as depicted in FIG. 18. For example, the body 1305 and/or the core 1330 may be at least partially a hollow. The body cavity 1325 may be defined by the body 1305, e.g., defined by the interior surface 1315 of the body 1305. For example, the body cavity 1325 may include space between the core 1330 and the interior surface 1315 of the body 1305. The core cavity 1350 may be defined by the core 1330, e.g., defined by the interior surface 1340 of the core 1330. The core 1330 and/or the core cavity 1350 may extend between the second opening 1345 and the third opening 1405. The core 1330 may comprise a hollow, tubular shape.

Substantially all of the core 1330 may be disposed in the body cavity 1325. For example, the core 1330 may extend from the second body end 1305c and/or the second core end 1330c and into the body cavity 1325. The first opening 1320 may lead to the body cavity 1325 and/or the core cavity 1350. For example, the first opening 1320 may expose the body cavity 1325, the core 1330, and/or the core cavity 1350 to an environment external the animal enrichment device 1300. In this way, substances may be received by the body cavity 1325 and/or the core cavity 1350. Likewise, an animal may be enabled to engage with the body cavity 1320, the interior surface 1315 of the body 1305, and the core 1330, including the core interior surface 1340, the core exterior surface 1335, and the core cavity 1350.

The core cavity 1350 may receive a substance, such as a first substance. The body cavity 1325 may receive a substance, such as a second substance. The first substance and/or the second substance may include food, treats, medicine and the like. The first substance and the second substance may be the same as each other or may be different than each other. A user or animal owner may load the core cavity 1350 with the first substance through the second opening 1345 and/or the third opening 1405. For example, the user may insert the first substance through the second opening 1345 and/or the third opening 1405 into the core cavity 1350. In the examples where the user inserts the first substance through the second opening 1345, the user may consequently insert the first substance through the first opening 1320. A user or animal owner may load the body cavity 1325 with the second substance through the first opening 1320. For example, a user or animal owner may insert the second substance through the first opening 1320 and into the body cavity 1325. In some examples, the substance may pass from the core cavity 1350 into the body cavity 1325. In these examples, a user may indirectly insert the substance through the third opening 1405 into the body cavity 1325.

Since the core length 1330a may be less than the body length 1305a, the second opening 1345 may be within the body cavity 1325. In this way, a substance within the core cavity 1350 may be inhibited from exposure to substances external the animal enrichment device 1300, which may improve sanitation for the end user or animal. For example, the third opening 1405 may be closed or covered. Such embodiments may include a removable or at least partially detachable covering, cap, lid, plug, and/or other configurations known in the art. In another example, the third opening 1405 may include a deformable material and may define a slit that is similar to, or the same as, the slit of the discharge point 930 seen in FIGS. 9a-10B. In this example, an external substance may be inhibited from entering the core cavity 1350 through the third opening 1405. In other examples, the substance received within the core cavity 1350 may adhere to the interior surface 1340 of the core 1330. For example, the core cavity 1350 may receive a sticky substance, such as peanut butter, and an animal may engage the animal enrichment device 1300 from the first opening 1320, the second opening 1345, and/or the third opening 1405 and extract the sticky substance.

The body 1305 may be in or may have a variety different shapes, such as a ball, a cube, a pyramid, and/or other configurations known in the art. For example, the body 1305 may be or may have a substantially spherical shape, a truncated spherical shape, a double truncated spherical shape, and/or other configurations known in the art. For example, the body 1305 may include a double truncated spherical shape and the truncations may be opposite each other, as depicted in FIG. 15. It is contemplated that a first opening 1320 comprises a first truncated spherical shape location, e.g., the first body end 1305b, and the third opening 1405 may be a second truncated spherical shape location, e.g., the second body end 1305c.

In examples where the body 1305 includes a spherical shape, the body length 1305a may comprise a diameter of the body 1305. The core 1330 may comprise one or more of a variety different shapes, such as a funnel, a cylinder, a cone, and/or other configurations known in the art. For example, the core 1330 may be a cylindrically shaped funnel or tube, as depicted in FIG. 15.

The first opening 1320, the second opening 1345, and/or the third opening 1405 may also comprise a variety different shapes, such as a circle, a square, a triangle, and/or other configurations known in the art. In examples where the first opening 1320, the second opening 1345, and, the third opening 1405 are circular, the first opening length 1605 may be a diameter of the first opening 1320, the second opening length 1610 may be a diameter of the second opening 1345, and the third opening length 1705 may be a diameter of the third opening 1405.

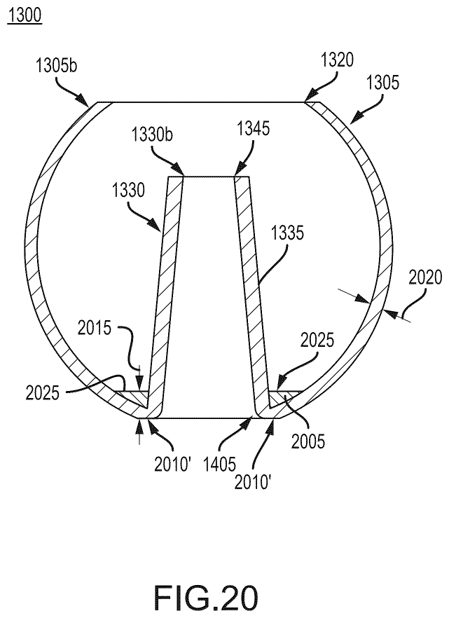

FIG. 20 depicts an example of the body 1305 identifying an exterior surface 2010′ located at a second body end 1305c and further comprising a bottom portion 2005. It is contemplated that the bottom portion 2005 may be integrated to the body 1305 and the exterior surface 1335 of the core 1330. For example, the bottom portion 2005 may comprise a substantially flat interior bottom surface 2025 of the body 1305. Similarly, the exterior surface 2010′ at the bottom of the device 1300 may also comprise a substantially flat surface. The exterior surface 2010′ and interior surface may be substantially parallelly aligned with the first body end 1305b and/or the first core end 1330b, e.g., substantially parallelly aligned with a top surface of the animal enrichment device 1300, such as the top surface of the body 1305 and/or the top surface the core 1330. In other examples, the substantially flat interior bottom surface 2025 and/or the exterior surface 2010′ may be rounded or may include angles.

The bottom portion 2005 of the body 1305 may include a thickness 2015. The thickness 2015 may extend between the exterior surface 2010′ of the body 1305 and the substantially flat interior bottom surface 2025 of the bottom portion 2005. The thickness 2015 may be greater than a thickness 2020 of the body 1305. For example, the thickness 2020 of the body 1305 may be greater than or equal to about 1% and less than or equal to about 80% of the thickness 2015 of the bottom portion 2005. For example, the thickness 2020 of the body 1305 may be about 20% of the thickness 2015 of the bottom portion 2005. In these examples, the animal enrichment device 1300 may comprise a uniform material. The portion of the device proximal the second body end 1305c may have a greater mass, and therefore such portion may have a greater weight, than the portion of the device proximal the first body end 1305b. Therefore, during animal engagement with the device 1300, the device may be structured to return to a resting position in which the exterior surface 2010′ contacts a ground surface and the first opening 1320 is inhibited from contacting the ground surface. In other examples, the bottom portion 2005 may include a different material than the rest of the body 1305, e.g., a heavier material. In this example, although the thickness 2015 of the bottom portion 2005 and the thickness 2020 of the body 1305 may be substantially equal (not shown in FIG. 20), the animal enrichment device 1300 may still be structured to return to a resting position in which the exterior surface 2010′ contacts a ground surface and the first opening 1320 is inhibited from contacting the ground surface. For example, the bottom portion 2005, the elements at the second body end 1305c, and the elements at the second core end 1330c may together weigh more than the rest of the animal enrichment device 1300, despite the thickness 2015 of the bottom portion 2005 and the thickness 2020 of the body 1305 being equal. For example, the body 1305 may comprise a uniform thickness, yet the weight distribution of the animal enrichment device 1300 may still cause the animal enrichment device 1300 to return to the resting position.

In some examples, the thickness 2020 of the body 1305 may be greater than or equal to about 1 millimeter and less than or equal to about 15 millimeter. For example, the thickness 2020 of the body 1305 may be greater than or equal to about 4 millimeter and less than or equal to about 8 millimeter. For example, the thickness 2020 of the body 1305 may be about 4 millimeters. In some examples, the thickness 2015 of the bottom portion 2005 may be greater than or equal to about 4 millimeter and less than or equal to about 24 millimeter. For example, the thickness 2015 of the bottom portion 2005 may be about 12 millimeters.

In other examples, the thickness 2020 of the body 1305 is uniform, e.g., the thickness 2015 of the bottom portion 2005 and the thickness 2020 of the body 1305 may be substantially equal, and the material of the body 1305 is uniform.

Any of the features, components, and/or parts, including the arrangements and configurations thereof shown in FIGS. 13-20 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 13-20.

The word “herein” includes the descriptions provided throughout this specification, including the Field, Background, Summary, Brief Description of the Drawings, Detailed Description, Claims, and Abstract. The word “exemplary” is used herein to mean “serving as an example, instance, or illustration.” Any embodiment described herein as “exemplary” is not necessarily to be construed as preferred or advantageous over other embodiments. The terms “a” or “an” herein are to be construed as open ended, e.g., meaning “at least one”. For example, “X may include a Y” is to be construed as, “X may include at least one Y”, unless specifically stated otherwise. The terms “about” and “substantially” herein are to be construed as +/−10%, including the number or word listed, unless stated otherwise. Every range of values (of the form, “from about a to about b,” or, equivalently, “from approximately a to b,” or, equivalently, “from approximately a-b” or, equivalently, “greater than about a and less than about b”, for example) disclosed herein is to be understood to set forth every number and range encompassed within the broader range of values. As used herein, directional terms such as “left”, “right”, “above”, “below”, “over”, and “under” can be with respect to an operational orientation of the disclosed systems and methods or as the disclosed systems is oriented in the figures. As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

It should be understood that logical operations may be performed in any order, unless explicitly claimed otherwise or a specific order is inherently necessitated by the claim language. Additionally, some of the operations described may be skipped or not included. In methodologies directly or indirectly set forth herein, various steps and operations are described in one possible order of operation but those skilled in the art will recognize the steps and operation may be rearranged, replaced, or eliminated without necessarily departing from the spirit and scope of the present disclosure. It is intended that all matter contained in the above description or shown in the accompanying drawings shall be interpreted as illustrative only and not limiting. Changes in detail or structure may be made without departing from the spirit of the present disclosure as defined in the appended claims.

Other examples and implementations are within the scope and spirit of the disclosure and appended claims. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings

1-9. (canceled)

10. An animal enrichment device comprising:
a body having an interior surface and a body length;
a body cavity defined by the interior surface of the body;
a core extending into the body cavity and having a core length;
a first opening defined by a top portion of the body and exposing the body cavity and the core;
a second opening defined by the core;
a third opening defined by the body and by the core; and
a core cavity defined by the core and extending between the second opening and the third opening;
wherein:
the core length is less than the body length and the second opening is within the body cavity;
the first opening having a first opening length defined between a first edge at least partially defining the first opening and a second edge at least partially defining the first opening opposite the first edge of the first opening;
the second opening having a second opening length defined between a first edge at least partially defining the second opening and a second edge at least partially defining the second opening opposite the first edge of the second opening;
the first opening length is greater than the second opening length;
the third opening having a third opening length defined between a first edge at least partially defining the third opening and a second edge at least partially defining the third opening opposite the first edge of the third opening, wherein the third opening length is greater than or equal to the second opening length and less than or equal to the first opening length.

11. (canceled)

12. The animal enrichment device of claim 10, wherein:
the body having a first body end opposite a second body end;
the first opening defined by the body at the first body end; and
the third opening defined by the body at the second body end.

13. The animal enrichment device of claim 10, wherein:
the core having a first core end opposite a second core end;
the second opening defined by the core at the first core end; and
the third opening defined by the core at the second core end.

14. (canceled)

15. The animal enrichment device of claim 10, wherein:
the body having a spherical shape;
the first opening truncating a first portion of the spherical shape; and
the third opening truncating a second portion of the spherical shape.

16. The animal enrichment device of claim 10, wherein:
the core cavity is configured to receive a first substance; and
the body cavity is configured to receive a second substance.

17. The animal enrichment device of claim 10, wherein:
the body having an exterior surface;
the core having an interior surface and an exterior surface;
the exterior surface of the body transitions into the interior surface of the core; and
the interior surface of the body transitions into the exterior surface of the core.

18. The animal enrichment device of claim 10, wherein:
the body having a bottom portion;
the bottom portion of the body having an exterior surface that is substantially flat; and
the bottom portion of the body having a thickness greater than a thickness of the body.

19. The animal enrichment device of claim 10, wherein:
the body comprises an elastomeric material.

20. The animal enrichment device of claim 10, wherein:
the core length is greater than or equal to about 20% and less than or equal to about 80% of the body length.

21. (canceled)

22. An animal enrichment device comprising:
a body having an interior surface and a body length;
a body cavity defined by the interior surface of the body;
a core extending into the body cavity and having a core length;
a first opening defined by a top portion of the body and exposing the body cavity and the core;
a second opening defined by the core; and
a third opening defined by the body and by the core;
wherein:
the core length is less than the body length and the second opening is within the body cavity;
the first opening having a first opening length defined between a first edge at least partially defining the first opening and a second edge at least partially defining the first opening opposite the first edge of the first opening;
the second opening having a second opening length defined between a first edge at least partially defining the second opening and a second edge at least partially defining the second opening opposite the first edge of the second opening, wherein the first opening length is greater than the second opening length; and
the third opening having a third opening length defined between a first edge at least partially defining the third opening and a second edge at least partially defining the third opening opposite the first edge of the third opening, wherein the third opening length is greater than or equal to the second opening length and less than or equal to the first opening length.

23. The animal enrichment device of claim 22, further comprising:
a core cavity defined by the core and extending between the second opening and the third opening.

24. The animal enrichment device of claim 22, wherein:
the body having a spherical shape;
the first opening truncating a first portion of the spherical shape; and
the third opening truncating a second portion of the spherical shape.

25. The animal enrichment device of claim 22, wherein:
the body having a bottom portion;
the bottom portion of the body having an exterior surface that is substantially flat; and
the bottom portion of the body having a thickness greater than a thickness of the body.

26. An animal enrichment device comprising:
a body having an interior surface, a body length, and a spherical shape;
a body cavity defined by the interior surface of the body;
a core extending into the body cavity and having a core length;
a first opening defined by a top portion of the body and exposing the body cavity and the core, the first opening having a first opening length defined between a first edge at least partially defining the first opening and a second edge at least partially defining the first opening opposite the first edge of the first opening;
a second opening defined by the core and having a second opening length defined between a first edge at least partially defining the second opening and a second edge at least partially defining the second opening opposite the first edge of the second opening;
a third opening defined by the body and by the core; and
a core cavity defined by the core and extending between the second opening and the third opening;
wherein:
the first opening length is greater than the second opening length;
the core length is less than the body length and the second opening is within the body cavity;
the first opening truncating a first portion of the spherical shape of the body;
the third opening having a third opening length defined between a first edge at least partially defining the third opening and a second edge at least partially defining the third opening opposite the first edge of the third opening, wherein the third opening length is greater than or equal to the second opening length and less than or equal to the first opening length.

27. (canceled)

28. The animal enrichment device of claim 26, wherein:
the third opening truncating a second portion of the spherical shape;
the body having a bottom portion;
the bottom portion of the body having an exterior surface that is substantially flat; and
the bottom portion of the body having a thickness greater than a thickness of the body.

29. An animal enrichment device comprising:
a body having an interior surface and a body length;
a body cavity defined by the interior surface of the body;
a core extending into the body cavity and having a core length;
a first opening defined by a top portion of the body and exposing the body cavity and the core;
a second opening defined by the core;
a third opening defined by the body and by the core; and
a core cavity defined by the core and extending between the second opening and the third opening;
wherein:
the core length is less than the body length and the second opening is within the body cavity;
the body having a bottom portion;
the bottom portion of the body having an exterior surface that is substantially flat;
the bottom portion of the body having a thickness greater than a thickness of the body;
the first opening having a first opening length;
the second opening having a second opening length, wherein the first opening length is greater than the second opening length;
the third opening having a third opening length, wherein the third opening length is greater than or equal to the second opening length and less than or equal to the first opening length.

30. (canceled)

31. The animal enrichment device of claim 29, wherein:
the body having a spherical shape;
the first opening truncating a first portion of the spherical shape; and
the third opening truncating a second portion of the spherical shape.

32. The animal enrichment device of claim 22, wherein:
the body having an exterior surface;
the core having an interior surface and an exterior surface;
the exterior surface of the body transitions into the interior surface of the core; and
the interior surface of the body transitions into the exterior surface of the core.

33. The animal enrichment device of claim 26, wherein:
the body having an exterior surface;
the core having an interior surface and an exterior surface;
the exterior surface of the body transitions into the interior surface of the core; and
the interior surface of the body transitions into the exterior surface of the core.

34. The animal enrichment device of claim 26, wherein:
the body comprises an elastomeric material.

35. The animal enrichment device of claim 29, wherein:
the body having an outer surface;
the core having an interior surface and an exterior surface;
the outer surface of the body transitions into the interior surface of the core; and
the interior surface of the body transitions into the exterior surface of the core.
